(19) United States
(12) Patent Application Publication
(10) Pub. No.: US 2022/0089295 A1
(43) Pub. Date: Mar. 24, 2022

(54) UNMANNED AERIAL VEHICLE CAPSULE

(71) Applicant: SPEAR U.A.V LTD, Tel Aviv (IL)

(72) Inventor: Gedalia KUPERMAN, Tel Aviv (IL)

(73) Assignee: SPEAR U.A.V LTD, Tel Aviv (IL)

(21) Appl. No.: 17/310,000

(22) PCT Filed: Jan. 9, 2020
(86) PCT No.: PCT/IL2020/050039

§ 371 Date: Jul. 9, 2021

Related U.S. Application Data
(60) Provisional application No. 62/790,494, filed on Jan. 10, 2019.

(51) Int. Cl. B64F 5/40; B64C 39/02

(52) U.S. Cl. CPC B64F 5/40; B64C 2201/201; B64C 39/024

(57) ABSTRACT

Provided is a designated Unmanned Aerial Vehicle (UAV) capsule, including: a capsule body, including a UAV; and at least one maintenance connector; and a support controller included in one of the capsule body and the UAV; wherein the support controller is connected with the UAV and the at least one maintenance connector and configured to enable at least one of support actions and maintenance actions in the UAV while the UAV remains encapsulated in the capsule body.

### CROSS-REFERENCE TO RELATED PATENT APPLICATIONS

This patent application claims priority from and is related to U.S. Provisional Patent Application Ser. No. 62/790,494, filed Jan. 10, 2019, this U.S. Provisional Patent Application incorporated by reference in its entirety herein.

### FIELD OF THE INVENTION

The present invention generally relates to Unmanned Aerial Vehicles (UAVs) and specifically to a UAV that is supplied in a sealed capsule providing for its long-term storage and maintenance, and intended to be launched from an existing or purpose-built canister launcher with the capsule serving as conveniently reloadable ammunition for the launcher.

### BACKGROUND

Unmanned Aerial Vehicles have been used in recent years for military and civilian uses such as observation platforms, loitering munitions and carriers for various research and intelligence sensors. UAV's are traditionally launched by taking the drone out of a storage container or shelter, optionally assembling it, preparing it for its mission using support and test equipment, and commanding the UAV to take-off vertically or horizontally, either manually by an operator controlling the vehicle's movement, or by an automated takeoff command allowing the vehicle to take-off autonomously.

This traditional process is cumbersome, requiring space to store the UAV and allow it to take-off, tools and equipment to assemble and/or prepare it, time for the whole process to take place and one or more well-trained personnel capable of executing the assembly, preparation and/or takeoff processes without harming the delicate UAV. Accordingly, UAV capabilities have been traditionally tied to fixed infrastructure such as an airbase, to specialized operators or units capable of deploying UAV's in the field or to applications where personnel in the field have time and room to safely launch a UAV when needed, and can accommodate the workload associated with maintaining a UAV system. Accordingly, there are many applications where the use of UAVs is limited to services supplied by external organizations, due to the inability to accommodate the overhead associated with launching and maintaining a UAV. Additionally, infrastructure constraints may force the UAV to be launched from a point that is convenient for launching but distance from the target area, requiring the UAV to spend time and energy reaching the target area under its own power, thus increasing reaction time and reducing the time spent at the target area.

There are several known solutions in the art, which improve upon this traditional system:
“Drone in a Box” systems, which contain a drone and the equipment needed to prepare, launch, recover and turn-around the drone. At the press of a button, a drone autonomously takes off from the box, conducts its mission and then autonomously returns to the box where it is automatically prepared for the next mission. These systems, while providing excellent convenience to the user, are highly expensive, costing an order of magnitude more than the drone itself.

These systems additionally require that the box be stationary or moving within a limited envelope, since the moving box must still provide a suitable place for the drone to take off and land. The box, being a complicated piece of equipment, is difficult to maintain, and faults in the box may require a replacement box or specialized technicians to be sent to the site, imposing significant logistical requirements on long-term operation. The cost of each box may additionally force it to be deployed at a secure area far from the region of interest.
Canister-launched drones, where a drone can be folded and inserted into a canister and launched from an existing launcher such as a launch tube. After the canister is launched, the drone leaves it, unfolds and begins flight. This solution allows drones to be easily deployed from vehicles without requiring dedicated space for the drone to take off (e.g., a runway or a helipad). Additionally, the capsule may be launched in a situation where the bare drone could not launch (e.g., underwater), with the capsule moving to a suitable position for the drone (e.g., floating to the surface). However, the manual process of loading the canisters and testing or preparing the drones still requires specialized labor on site or on the supply chain leading to the site, and the need to store and transport bare drones to the site imposes logistical and operational constrains (e.g., large, padded transport containers, dedicated storage spaces and canister assembly workstations). Additionally, the canister solutions known in the art are specifically tailored for uncommon types of launchers, where a canister is dropped or ejected out of a tube with a mild push, a method not suitable for land vehicles.
Self-contained drone launchers, which comprise one or more launch tubes containing drones ready for launch, where the drones are typically loitering munitions. These launchers are supplied filled with drones and comprise the support equipment needed to test it and prepare it for launch. While convenient, these launchers are considerably larger and more expensive than the bare drones, possibly making the launcher itself a significant piece of infrastructure too difficult or large for some uses. Additionally, the launchers are either disposable or require specialized work to reload, meaning long-term use would require fresh launchers to be continually transported to the site, and spent launchers to be either wastefully disposed of or returned to a depot for reloading.
Launchable drones, where the drone itself can be folded into a shape which allows it to be loaded into the bore of a launcher, which can later be used to eject the drone, allowing it to unfold and begin flying. While the launchable drone is logistically compact and may utilize an existing launcher, its design is burdened by the need to make it both an aircraft and a projectile, making for an expensive drone that is heavier and thus lower in performance, and personnel on site still need to test and prepare it much like a regular drone. Additionally, the launchable drone design requires a powered launcher with a significant footprint and is highly specialized to one launcher type, making it inapplicable for certain applications or requiring an expensive redesign to adapt it.

Therefore, there is a need for a solution allowing drones to be deployed in the field from various platforms, without burdensome infrastructure or logistics requirements, operable and serviceable by minimal and minimally trained personnel, all while maintaining low costs and high drone performance.

### SUMMARY

According to an aspect of the present invention there is provided a designated Unmanned Aerial Vehicle (UAV) capsule, comprising: a capsule body, comprising a UAV; and at least one maintenance connector; and a support controller comprised in one of the capsule body and the UAV; wherein the support controller is connected with the UAV and the at least one maintenance connector and configured to enable at least one of support actions and maintenance actions in the UAV while the UAV remains encapsulated in the capsule body.

The UAV may be entirely encapsulated inside the capsule.

At least a part of the UAV may form at least a part of the capsule body.

The at least one of support actions and maintenance actions may be selected from the group consisting of: turning the UAV on; carrying out at least one pre-flight test; carrying out at least one pre-launch test; loading data indicative of a mission to be performed; and placing the UAV in a state of readiness for launch.

The at least one of support actions and maintenance actions may be selected from the group consisting of: updating software; updating firmware; charging batteries; and discharging batteries.

The capsule may be configured to perform a bootstrap process upon being activated, comprising: transitioning between at least two states in a sequence comprising a low-power state suitable for long-term and a state of immediate readiness for launch; and stopping at at least one state in the sequence, and continuing the sequence according to at least one of: awaiting at least one of a command or a signal to continue the sequence, completion of an internal process in the capsule and occurrence of a launch event.

The sequence may comprise at least two of a powered-off state where the capsule is essentially powered-off and awaits a power-on signal; an intermediate state where the capsule is minimally activated and awaits a standby command; a standby state where the capsule is further activated and awaits a readiness for launch command; and a ready state where the capsule awaits the capsule's launch.

According to another aspect of the present invention there is provided a method of enabling at least one of support actions and maintenance actions in a UAV, comprising: providing a capsule body, comprising a UAV; and at least one maintenance connector; and a support controller comprised in one of the capsule body and the UAV; enabling at least one of support actions and maintenance actions in the UAV while the UAV remains encapsulated in the capsule body.

The UAV may be entirely encapsulated inside the capsule.

At least a part of the UAV may form at least a part of the capsule body.

The at least one of support actions and maintenance actions may be selected from the group consisting of: turning the UAV on; carrying out at least one pre-flight test; carrying out at least one pre-launch test; loading data indicative of a mission to be performed; and placing the UAV in a state of readiness for launch.

The at least one of support actions and maintenance actions may be selected from the group consisting of: updating software; updating firmware; charging batteries; and discharging batteries.

The method may further comprise performing a bootstrap process upon being activated, comprising: transitioning between at least two states in a sequence comprising a low-power state suitable for long-term and a state of immediate readiness for launch; and stopping at at least one state in the sequence, and continuing the sequence according to at least one of: awaiting at least one of a command or a signal to continue the sequence, completion of an internal process in the capsule and occurrence of a launch event.

The sequence may comprise at least two of: a powered-off state where the capsule is essentially powered-off and awaits a power-on signal; an intermediate state where the capsule is minimally activated and awaits a standby command; a standby state where the capsule is further activated and awaits a readiness for launch command; and a ready state where the capsule awaits the capsule's launch.

According to an aspect of the present invention there is provided a designated Unmanned Aerial Vehicle (UAV) capsule, comprising: a capsule body, comprising: a UAV; an initiation interface; and an active initiation mechanism connected with the initiation interface; wherein the active initiation mechanism is configured to cause the capsule to be actively launched; wherein the initiation interface of the capsule is configured to be connected with an initiation interface of a launcher; and wherein the capsule is configured to be actively launched upon a firing action received from the launcher via the connection between the initiation interface of the capsule and the initiation interface of the launcher.

The active initiation mechanism may be selected from the group consisting of propellant charge with ventilation vents, propellant charge without ventilation vents, a gas generator, a rocket motor, a preloaded compression spring and a compressed gas canister.

The firing action may be selected from the group consisting of a firing pin striking a primer or a button on the surface of the capsule, an electrical current capable of activating the initiation mechanism entering a terminal on the capsule and an order for activating the initiating mechanism delivered through a wired or wireless communication interface between the capsule and the launcher.

According to an aspect of the present invention there is provided a method of actively launching an Unmanned Aerial Vehicle (UAV) capsule, comprising: providing a capsule body, comprising: a UAV; an initiation interface; and an active initiation mechanism connected with the initiation interface; wherein the active initiation mechanism is configured to cause the capsule to be actively launched; wherein the initiation interface of the capsule is configured to be connected with an initiation interface of a launcher; and placing the capsule inside the launcher; receiving, by the capsule, a firing action from the launcher via the connection between the initiation interface of the capsule and the initiation interface of the launcher; and actively launching the capsule.

The active initiation mechanism may be selected from the group consisting of propellant charge with ventilation vents, propellant charge without ventilation vents, a gas generator, a rocket motor, a preloaded compression spring and a compressed gas canister.

The firing action may be selected from the group consisting of a firing pin striking a primer or a button on the surface of the capsule, an electrical current capable of activating the initiation mechanism entering a terminal on the capsule and an order for activating the initiating mechanism delivered through a wired or wireless communication interface between the capsule and the launcher.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 shows conventional exemplary canister launchers;

FIG. 2 is a schematic view of an exemplary designated capsule for carrying a UAV, according to embodiments of the present invention;

FIG. 2A is an exploded view of FIG. 2;

FIG. 2B shows an exemplary drone intended to be encapsulated inside the exemplary designated capsule of FIG. 2;

FIG. 3 shows an exemplary drone structure, according to embodiments of the present invention;

FIG. 4 shows another exemplary drone structure, according to embodiments of the present invention;

FIG. 5 shows an exemplary capsule designed to be launched from a smoke discharger, according to embodiments of the present invention;

FIG. 6 is a block diagram of a capsule and a UAV power distribution, according to one exemplary implementation;

FIG. 7 is block diagram showing the UAV capsule control flow, according to embodiments of the present invention; and

FIG. 8 shows an exemplary bootstrap process, according to embodiments of the present invention.

### DETAILED DESCRIPTION OF PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention provides a UAV capsule, which is a container housing a UAV in a folded or otherwise compacted state and configured to be loaded into a compatible launcher or holder, which can be placed at a target region or close to it. When a UAV is needed, an operator or connected system may activate the capsule and/or command the launcher to launch the capsule, triggering a sequence which ends with the UAV being released from the capsule and flying independently.

The present invention's UAVs may be intended to carry out a variety of missions, such as tracking moving targets, night reconnaissance, relaying communications and data, laser designation, measuring atmospheric conditions, search and rescue and more.

Upon completing the mission, depleting its energy reserves or encountering a technical problem, the UAV may either destroy itself, land in its current position or proceed to land at a different position as dictated by its mission or by its operator.

Since time and energy are saved on the flight to targets, the UAVs provide a tactical solution for executing long range missions with minimal reaction time and maximal endurance and payload capacity.

According to embodiments of the present invention, the UAV may be preprogrammed to perform a mission, guided from the launch platform or a combination of these two methods.

For the purpose of explanation and demonstration the UAV hereinafter is presented as a quadcopter or a drone. It will be appreciated that the present invention is not limited to a quadcopter or a drone. According to embodiments of the present invention, the UAV may be any drone having at least two arms, a multi rotor copter, a counter rotor copter or any other aerial vehicle capable of being launched folded.

The UAV capsule of the present invention is designed to allow the capsule to serve as a self-contained replaceable ammunition cartridge for a launcher, while ensuring that the UAV's servicing and support needs can be met without breaching the capsule or requiring a bare UAV to be handled in the field. This allows UAVs to be delivered from front-line or frontier areas, without requiring heavy infrastructure or dedicated crew to operate and service the system.

UAVs are provided in individually sealed capsules intended to securely house the UAV for its entire service life, until a release event, where the capsule is breached and safely separates from the UAV. The capsule enables it by implementing interfaces to the UAV that enable it to be serviced or maintained inside it, and by implementing interfaces to the launcher that enable the capsule to be loaded and launched from the launcher like a round of ammunition.

This differs from canister-launched UAVs or UAV launchers as seen in the prior art, by providing a capsule that is simultaneously a long-term protected storage space for the UAV, a replaceable ammunition cartridge for a launcher and a piece of support equipment enabling maintenance and testing of the UAV contained inside it.

According to embodiments of the present invention, the UAV capsule is intended to be used as a round of ammunition for a launcher, where the launcher may be an existing device, or one purpose-built for launching the UAV capsule. The launcher can be loaded or replenished with capsules in the field, without requiring the bare UAV to be exposed or handled, and without requiring the launcher to embody functionality specific to servicing or launching the UAV (e.g., it may be a device originally intended for different ammunition such as grenades which need no servicing while in the launcher).

The capsule's launching procedure is designed to match the launcher and the ammunition, allowing UAV capsules to be launched safely with minimal retraining and risk of mistakes, and possibly interchangeably with normal ammunition:
The capsule's external shape allows it to be loaded and launched from the launcher. The capsule would, for example, fit through the launcher's breech, bore or loading port where ammunition is loaded into the launcher. However, the capsule's shape may depart from the ammunition in a way that does not interfere with launching. For example, in a capsule designed to be loaded into the front of a launcher's barrel, the capsule may project outwards from the original ammunition's contour, occupying empty space in and/or out of the barrel.
In order to fit different launchers, the capsule may be fitted with a removable adapter providing at least a compatible mechanical interface between the capsule and a launcher, e.g., a sabot allowing a low-diameter capsule to be launched from a high-diameter launcher.
Where the ammunition incorporates safety and configuration mechanisms and procedures, the capsule may replicate these, at least in appearance and in general function (e.g., an arming mechanism may look outwardly identical and be used to arm the capsule, and have identical or different internal construction).
Where the ammunition incorporates interfaces intended to communicate or exchange signals with or through the launcher (e.g., a guided missile communicating with the launch platform to receive target coordinates through a wired data connection, or an artillery shell's fuse being set wirelessly through a STANAG 4369 inductive interface), the capsule may implement these interfaces, tying them to same or different functions in the capsule or UAV.
When integrating into launchers with self-propelled ammunition, the capsule may comprise propellant, and is intended to be triggered by the same firing signal provided by the launcher (e.g., a firing pin striking the exterior or the capsule, or an activation voltage entering a terminal). The propellant may be identical or different compared to the original ammunition.
The capsule's external shell may be intended to function in a way compatible with the shell of the original round of ammunition. For example, in a launcher designed to retain the spent shell or grip and eject it, the capsule's external shell may function identically. Similarly, in a launcher designed to have the entire round clear the launcher, the capsule's shell may be configured to clear the launcher and carry with it the rest of the capsule and the drone, leaving the launcher clear.

This contrasts with prior art, where the drone canister's launcher compatibility is restricted to having size and weight characteristics necessary to successfully pass through a tube or aperture, meaning the existing canisters can only be integrated into simple launchers that propel and eject a whole canister without any additional interfaces or steps in the process, and the act of loading and launching the canister may depart significantly from the act of loading the original ammunition.

According embodiments of the present invention, while the UAV is sealed in the capsule, it may need to be tested, charged, discharged, reconfigured or loaded with data necessary to complete its mission. In order to enable this, the capsule may incorporate interfaces, including electrical connectors, fluid ports, access doors, viewing ports and switches, connected to the UAV directly or through additional parts incorporated into the capsule.

These interfaces are designed in a way that maintains launcher compatibility (e.g., conformal to the capsule's contour and capable of withstanding the conditions of the launch) and provide selective access to the UAV to enable servicing. The capsule and UAV are configured such that the launch process results in the interfaces being disconnected, allowing the UAV to detach from the capsule completely.

Additionally, the UAV and capsule may comprise a support system comprising a computer controller and a power source, either built into the capsule or integrated into the UAV (either as additional units or as an additional function of the UAV's existing controllers and power sources). The support system may enable the UAV and capsule to be powered up in various partial configurations and/or provide external power (thus sparing the UAV's internal battery), allowing parts of the combined UAV and capsule system to be powered up individually for testing. The support system may additionally command and monitor parts of the UAV and capsule system, allowing them to be tested, serviced and reconfigured while the UAV is contained inside the capsule. The support system may operate with an external capsule tester, providing an interface to control the capsule's servicing and testing operation and receive test and servicing results. According to embodiments of the present invention, the capsule tester may be a purpose-built device solely dedicated the function or may be integrated as an additional function of existing equipment including but not limited to test equipment, canister launchers, UAV control stations, the UAV capsule itself and general purpose personal computers.

The support system may be used to enable support actions to be carried out with respect to the UAV and/or the capsule, including turning them on, carrying out preflight and/or pre-launch tests, loading data indicative of the mission to be performed and placing them in a state of readiness for launch, etc.

Additionally or alternatively, the support system may be used to enable maintenance actions to be carried out with respect to the UAV and/or the capsule, including carrying out tests, updating software and/or firmware and/or charging or discharging batteries, etc.

Contrary to the prior art, where drone-launching canisters provide no support facilities (requiring the drone to be extracted from the capsule prior to servicing) and purpose-built drone launchers provide limited support facilities (for example, preflight testing and configuration) directly to the bare drone without the protection of a capsule (meaning drones must be exposed while being loaded), the present invention implements support facilities while maintaining encapsulation, allowing launchers to be loaded with capsules, and drones to be maintained while safely inside the capsules at all stages of their lifecycle from production to launch.

According to embodiments of the present invention, the UAV and capsule may be configured so that the UAV and capsule undergo an automated and gradual transition from a state of low power consumption and no readiness for launch, to a state of higher power consumption and immediate readiness for launch, using a bootstrap process that acts on an external signal or action and automatically advances the UAV and capsule towards predefined states of readiness. The bootstrap process may include several stages, stopping at each stage to await a signal for advancing further.

Signals activating or advancing the bootstrap process may include, for example, physical switches being pressed manually before loading the capsule, switches being pressed or sensors being activated as a side-effect of the loading process, electrical communication between the capsule and the launcher and electrical communication between the capsule or the UAV and an instrument external to the launcher.

A bootstrap process with several stages may be used when it is undesirable to initiate a complete bootstrap process before it is loaded into the launcher, and also impractical to initiate a bootstrap process for each powered-down capsule in the launcher before it is launched. For example, in a launcher designed to operate for days without a known launch time, and with no available interface to provide a signal initiating the bootstrap of a powered-down unit, the capsule's bootstrap process may include an intermediate stage which consumes a small amount of power to enable the capsule to receive a further signal through means external to the launcher.

According to embodiments of the present invention, while the capsule is loaded into the launcher, an interface may be provided to communicate with and/or activate the UAV and/or the capsule, even when the launcher does not provide this function, using additional components affixed to the launcher or placed close to it, without interfering with the launch process. For example, a radio or optical transceiver may be positioned outside the launcher and communicate with a compatible unit built into the UAV and/or capsule. Alternatively, the capsule may incorporate, for example, electric or inductive contacts, designed to mate with contacts fitted into the launcher or an umbilical connector.

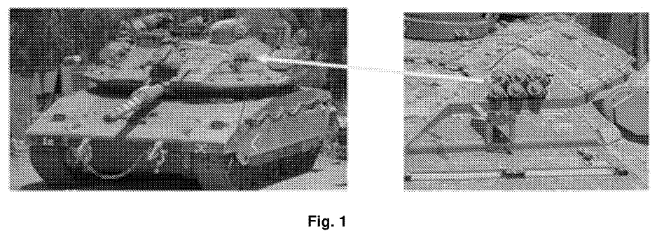

FIG. 1 shows conventional exemplary canister launchers.

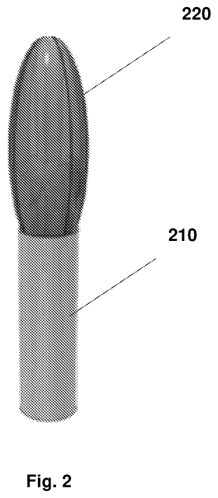

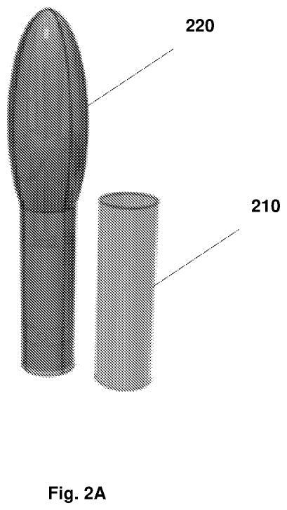

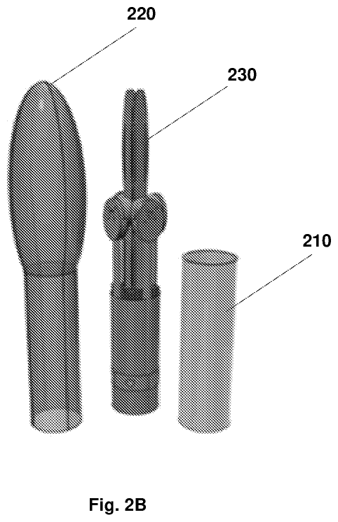

FIG. 2 is a schematic view of an exemplary designated capsule 220 for carrying a UAV, according to embodiments of the present invention. The capsule 220 is mounted in a conventional canister launcher 210, and is intended to be launched from the canister launcher using a designated inflator, a pneumatic pressure, or the like.

FIG. 2A is an exploded view of FIG. 2 showing:
1. A conventional canister launcher 210; and
2. The exemplary designated capsule 220.

The capsule 220 is launched from the canister launcher 210, splits and releases the UAV into the air.

FIG. 2B shows an exemplary drone 230 intended to be encapsulated inside the exemplary designated capsule 220.

In order to be encapsulated in a relatively narrow capsule which has to fit a conventional canister launcher, the UAV's structure has to be narrow.

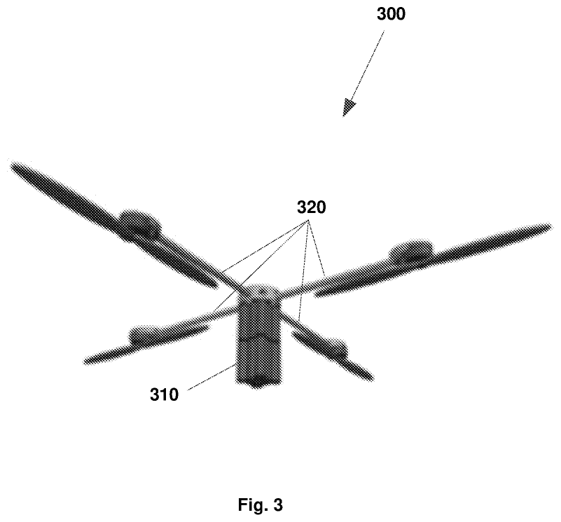

FIG. 3 shows an exemplary drone structure 300, according to embodiments of the present invention. In this embodiment the batteries' 310 and arms' 320 size and shape are designed according to the canister launcher's (210) size.

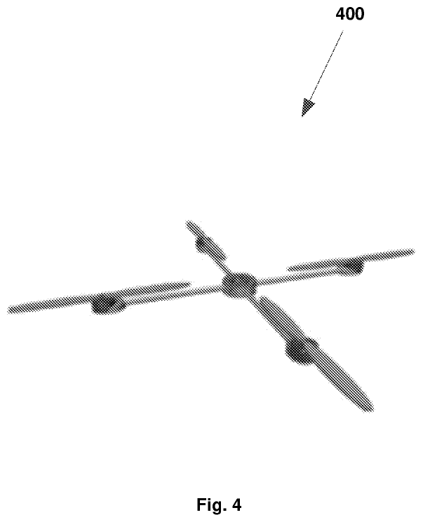

FIG. 4 shows another exemplary drone structure 400, according to embodiments of the present invention. In this embodiment the batteries are placed inside the arms.

According to embodiments of the present invention a number of UAVs may be launched from a single conventional canister launcher one after another.

According to embodiments of the present invention, the detachable capsule of the present invention may be designed to fit any canister launcher from which it should be launched.

According to embodiments of the present invention, the UAV capsule functions as a round of ammunition from the launcher, allowing it to be loaded into the launcher and launched from it, leading to the UAV being released from the capsule. The capsule implements design features that are necessary to make it compatible with the launcher, adds specific features which are needed to accommodate the UAV inside, and alters or omits features which are typical of ammunition but are incompatible with the UAV or unnecessary.

According to an exemplary implementation, the UAV capsule may be designed to be compatible with a smoke discharger, as commonly fitted onto military or security vehicles. The capsule thus partially imitates the interfaces and mechanisms of a given smoke grenade intended for the discharger, enabling the discharger to be used as its launcher, with no modifications required from the original discharger. The capsule notably omits, adds or alters aspects of the given grenade's interfaces or mechanisms, allowing it to fully discharge its functions with respect to the UAV without sacrificing compatibility with the smoke discharger and while leveraging its proven safety mechanisms.

A given smoke grenade's interface may include a cylindrical outer casing of a given diameter and length, and an electrical connector accepting an electrical pulse from the smoke discharger serving as a firing signal. The given smoke grenade's safety and firing mechanism may include a first safety mechanism comprising a detachable grounding clip preventing electrical pulses from initiating the grenade, and a second safety mechanism comprising a spring-loaded safety pin preventing the grenade's smoke payload from being initiated, a spring-loaded setback pin which holds the safety pin in place and the discharger's bore which additionally holds the safety pin in place by preventing it from extending out of the given smoke grenade's body.

A given smoke grenade is fired by removing the grounding clip from the connector, loading the grenade into the launcher (thus connecting the connector to a matching one comprised in the discharger) and issuing a firing pulse through the connector. The pulse triggers a propellant charge and additionally begins to trigger the (the process is stopped by the safety pin) grenade's smoke payload. The propellant charge creates a large amount of gas, which is ejected through the ventilation ports and propels the grenade forward. This creates a strong recoil which pushes the grenade out of the discharger, and simultaneously pushes the setback pin backwards against the spring, allowing the safety pin to be pushed outwards by the spring until it contacts the discharger's bore, which stops it from being released. When the grenade exists the discharger's bore, the safety pin is fully pushed out by the spring, allowing the grenade's smoke payload to be initiated, causing smoke to be dispersed from the grenade as it flies out of the discharger.

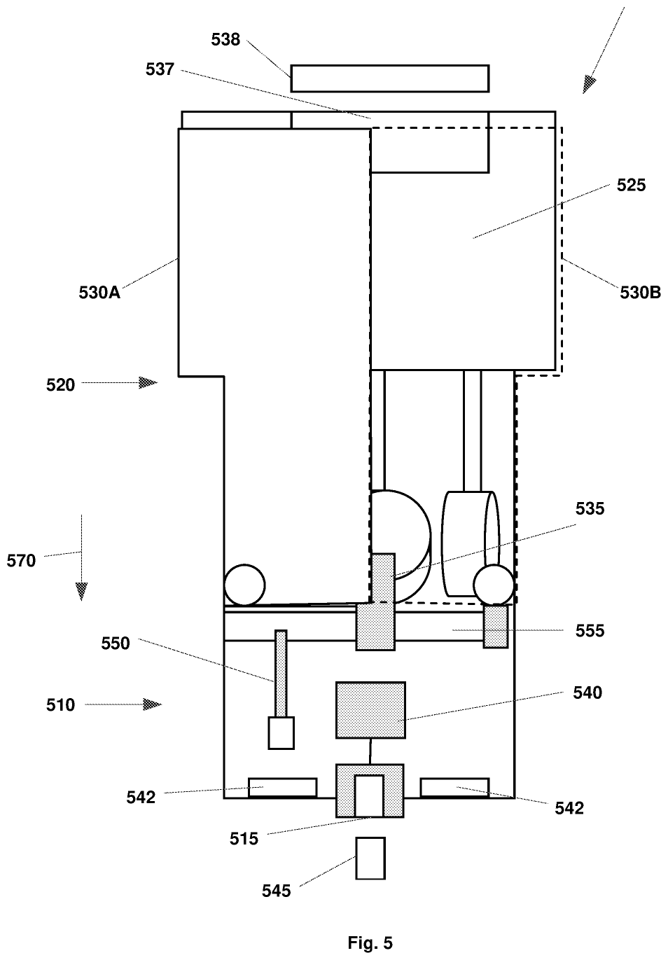

FIG. 5 shows an exemplary capsule 500 designed to be launched from the above described smoke discharger, according to embodiments of the present invention. The capsule 500 comprises a lower section 510 of roughly the same dimensions as the bore of the discharger, containing an electrical connector 515 similar to the one used in the given smoke grenade, allowing the capsule to be inserted into the discharger and fired using the existing firing signal, replicating the given grenade's interface. The capsule 500 further comprises an upper section 520, which protrudes from the bore of the discharger and affords further volume for the UAV and other capsule components, diverging from the given smoke grenade's interface while preserving compatibility with the discharger. The folded UAV 525 is located inside the capsule, mostly covered by a detachable fairing intended to split into at least two parts (two are shown, 530A and 530B, where 530B is represented by a dashed line which also serve as a section cut of the upper section). The parts are configured to fall apart and detach from the capsule once a safety catch 535 within the capsule is released. The portion of the UAV's body, not covered by the fairing, comprises at least one maintenance connector 537, which may be uncovered for maintenance by removing a cover 538.

It will be appreciated that in the above embodiment, the uncovered portion of the UAV's body serves concurrently as part of the UAV's body and part of the capsule's body, since it is comprised in the capsule's external contour while the UAV is encapsulated, and flies along with the UAV after it is released. It will further be appreciated that the maintenance connection may be located in a portion of the capsule's body that does not form a part of the UAV's body, in which case the connector detaches from the UAV as it is released.

The capsule's electrical connection is configured to allow an electrical pulse to initiate a propellant charge 540 which generates a large amount of gas that is ejected from ventilation vents 542 at the bottom of the capsule, propelling it forward at a high velocity. The electrical connection may be fitted with a grounding clip 545 preventing this initiation, duplicating the given smoke grenade's firing and initial safety mechanisms. The capsule 500 further comprises a setback pin 550 and an internal safety pin 555, duplicating the given smoke grenade's first safety mechanism. However, unlike the smoke grenade, the capsule's payload is the folded UAV. The folded UAV payload is initiated by the movement of the setback pin 550 in the direction of arrow 570, releasing the safety pin 555 which, upon ejection from the launcher, releases the safety catch 535, allowing the capsule's fairing parts to come apart and fall away from the UAV, freeing the UAV to unfold and begin flying independently. The capsule thus duplicates the general structure of the given smoke grenade's safety mechanism, while altering its function to fit the process of launching a UAV from within the capsule.

It will be appreciated that the principle of selectively adopting, altering or omitting the functionality of a round of ammunition can be applied to different kinds of existing or potential ammunition including for example, shells, missiles, rockets or other grenades, yielding in each case a capsule design that functions as a round of ammunition for a launcher while allowing the UAV to be launched successfully.

It will be appreciated that the connector 515 is not limited to be an electrical connector. Alternatively, connector 515 may serve as an initiation interface to be connected with an initiation interface of the launcher from which the capsule should be launched.

As can be shown in FIG. 5, according to embodiments of the present invention, a part of the UAV may constitute the upper section 520 of the capsule body and may comprise external connectors. Alternatively, the entire external surface of the UAV may be covered by the capsule body, with no portion left exposed while the UAV is encapsulated.

It will be appreciated that present invention is not limited to the location of the at least one maintenance connector as shown in FIG. 5. Alternatively, the at least one maintenance connector may be located anywhere on the capsule's body. Additionally, in a capsule design where part of the UAV constitutes part of the capsule body, the part of the capsule's body is not limited to be the upper section 520, and may be any portion of the capsule's body.

It will be appreciated that the propellant charge 540 and the ventilation vents 542 constitute an exemplary active initiation mechanism and the present invention is not limited to this exact active initiation mechanism. Alternatively, the active initiation mechanism may be a propellant charge without ventilation vents, a gas generator, a rocket motor, a preloaded compression spring, a compressed gas canister or other means of ejecting the capsule or a part thereof.

It will be appreciated that the initiation interface of the capsule is intended to be connected with an initiation interface of a launcher and the capsule is intended to be actively launched upon a firing action received from the launcher. The launching action may include the ejection of entire capsule or part of it from the launcher.

A firing action may be a firing pin striking a primer or a button on the surface of the capsule, an electrical current capable of activating the initiation mechanism entering a terminal on the capsule, an order for activating the initiating mechanism delivered through a wired or wireless communication interface between the capsule and the launcher, or another means of physically triggering or commanding the triggering of the active initiation mechanism.

According to another aspect of the present invention, the UAV capsule may function as a piece of support equipment for the UAV. The UAV may be housed in the capsule for a long period of time between its manufacturing and its launch, transitioning between storage, testing and loading into a launcher before finally being launched. As a piece of support equipment, the UAV capsule may provide functions assisting in testing, preparing, loading and launching the UAV, going further than merely encasing the UAV and allowing it to be launched out of a launcher.

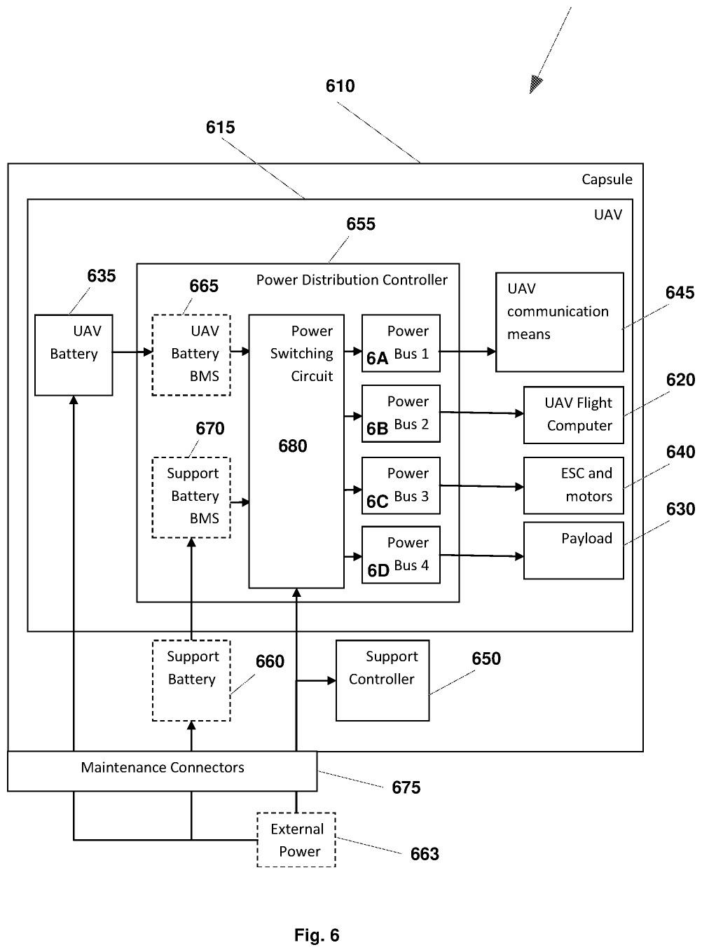

FIG. 6 is a block diagram 600 of the capsule 610 and UAV 615 power distribution, according to one exemplary implementation. The UAV 615 comprises at least one flight computer 620 which facilitate the UAV's flight, at least one payload 630, a battery 635 powering the UAV's flight, motors and speed controllers 640 applying thrust to achieve flight, as known in the art and communication means 645. In addition to these components or as an additional function embodied within them, the UAV and/or the capsule comprises a support controller 650 (shown as part of the capsule) and a power distribution controller 655, which facilitate aspects of the UAV's lifecycle outside flight or immediate preparation for flight. The UAV or capsule may additionally comprise a support battery 660 (shown as part of the capsule), distinct from the UAV's own battery.

According to embodiments of the present invention, the battery 635 and/or the support battery 600 and/or an external battery 663 may be connected with the power distribution controller (PDC) 655 via a battery management system 665 and/or 670, monitoring each battery's capability and health over time. The UAV and capsule are designed so that one or more maintenance connectors, electrically connected to relevant hardware in the UAV and capsule, can be exposed while keeping the capsule essentially sealed, allowing the UAV to be maintained without being removed from the capsule or without breaking the capsule's seal, affording easy and foolproof maintenance. A capsule tester, comprising for example a tablet computer, a battery charger and a cable harness, may be connected to a capsule's maintenance connectors 675 to allow a user to test, maintain or prepare the capsule for use using a set of maintenance operations conducted by the combined operation of the capsule tester, support controller 650 and power distribution controller 655, manipulating the capsule and UAV to achieve a desired result. These operations may include, for example, a self-test operation, a battery charge adjustment operation, a preparation for mission operation, etc.

The power distribution controller 655 comprises power switching circuits 680, allowing each of the batteries comprised in the UAV or the capsule or external power which may be provided through the maintenance connectors, to be connected to or disconnected from at least one power bus (four are shown, 6A-6D) supplying power to subsets of the UAV and capsule's electronics, selecting the UAV and capsule's power source as appropriate. The support controller 650 is operatively connected to the power distribution controller 655, the flight computer and other electronic units within the capsule or UAV, capable of commanding them and controlling their status.

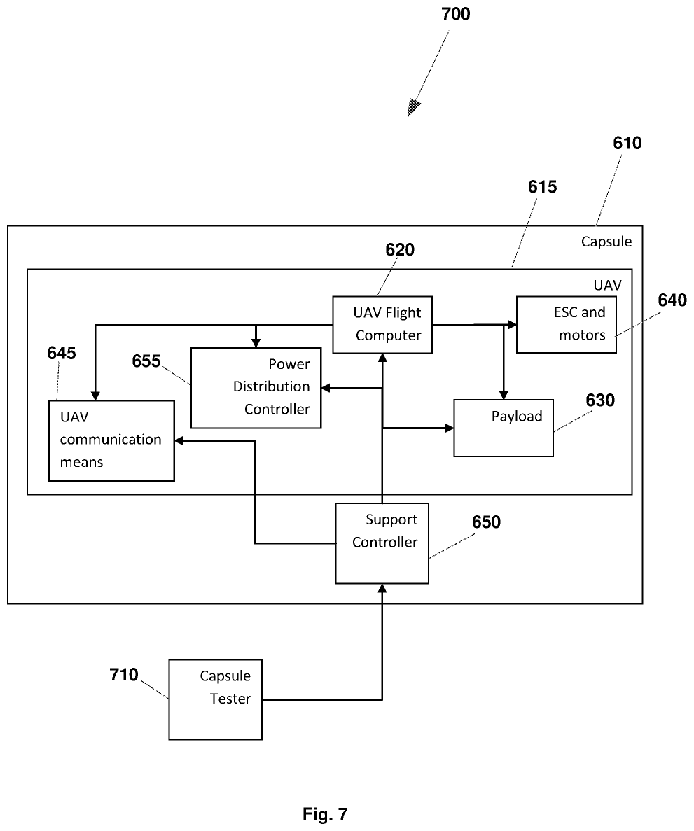

FIG. 7 is block diagram 700 showing the UAV capsule control flow, according to embodiments of the present invention. In a self-test operation, a capsule tester 710 may command the support controller 650 to carry out a series of tests, in which the support controller commands the power distribution 655 to supply power to activate various of the UAV and capsule's electronics and then communicates with them to check their status, declaring units are faulty when they explicitly report a fault or when their responses fall outside limits defined for each test. The support controller reports these combined results to the capsule tester, allowing a faulty unit to be detected.

In a charge adjustment operation, the capsule tester 710, either automatically or by operator command, determines a predicted use pattern for the capsule, selecting, for example, from long-term storage, readiness for immediate use or readiness for use at a chosen future date. The capsule tester 710 commands the support controller 650 to check the batteries, and the support computer queries the power distribution controller for the BMS (battery management system) status of each controller, indicating each battery's state of charge and health. Based on the chosen use pattern and the batteries' status, the capsule tester or support controller may run a battery optimization algorithm determining the required state of charge for the battery. For example, the algorithm may require the batteries to be charged to 100% for immediate use, discharged to 30% for long-term usage and charged or discharged to a value between 30% and 100% for use at a future date, with the value determined by the date and the batteries' health status. With the required state of charge provided by the algorithm, the capsule tester may command a charger to adjust the charge, or alternately advise the operator to manually operate the charger, allowing the charger to charge or discharge the batteries through the maintenance connectors (675 of FIG. 6) and reach the required state of charge.

In a preparation for mission operation, the capsule tester 710 may transfer information to the support controller 650, indicative of a mission plan to be executed by the UAV and/or configuration information pertinent to the UAV's execution of missions and/or to the operation of its payloads 630. The controller may store this information for later use, additionally or alternating powering up various units within the UAV and transferring the pertinent information to them (e.g., turning on the UAV's flight computer and transferring waypoints for a predefined flight path).

It will be appreciated that the power distribution diagram of FIG. 6 and the control flow diagram of FIG. 7 are presented for the purpose of explanation and demonstration and the UAV and/or capsule are not limited to these exact components. Alternatively, more or less components may be used.

It will be appreciated that for clarity, FIG. 6 and FIG. 7 show exemplary configurations and certain components or interfaces may be omitted, added, integrated in one another or act as separate modules. For example, the motors may be connected to the PDC indirectly through one or more Electronic Speed Controllers (ESC, not shown), and the one or more ESCs may be controlled by the flight controller in order to adjust the rotational speed of the motors. Additionally or alternatively, the functions of the flight controller and/or the PDC may be split among two or more discrete components within the UAV (e.g., a PDC and a separate voltage converter module, or a flight controller and a separate companion computer), the ESC may be integrated in the PDC or may be a separate component and the support controller may be integrated in the UAV's controller or be an external controller.

According to another aspect of the present invention, a UAV and capsule may comprise a bootstrap process, covering a gradual transition from a low-power state suitable for long-term storage to a state of immediate readiness for launch/release, carried out automatically with optional stops in the process when required. A typical transition from a power-off state to readiness to launch/release requires time and user interaction and/or automatically places the UAV in a state of relatively high power consumption, making it unusable when the capsule may spend a long time loaded into a launcher, where it may not be reachable and when it may spend long periods of time with its time of launch/release unknown. The bootstrap process is intended to accommodate needs particular to UAV release, the need to quickly prepare the UAV for use without intensive human intervention and conserve its internal battery for flight, while addressing use patterns where capsules may spend a long time in the launcher without a known launch time, and launcher designs may not allow capsules to be conveniently turned on while loaded into the launcher.

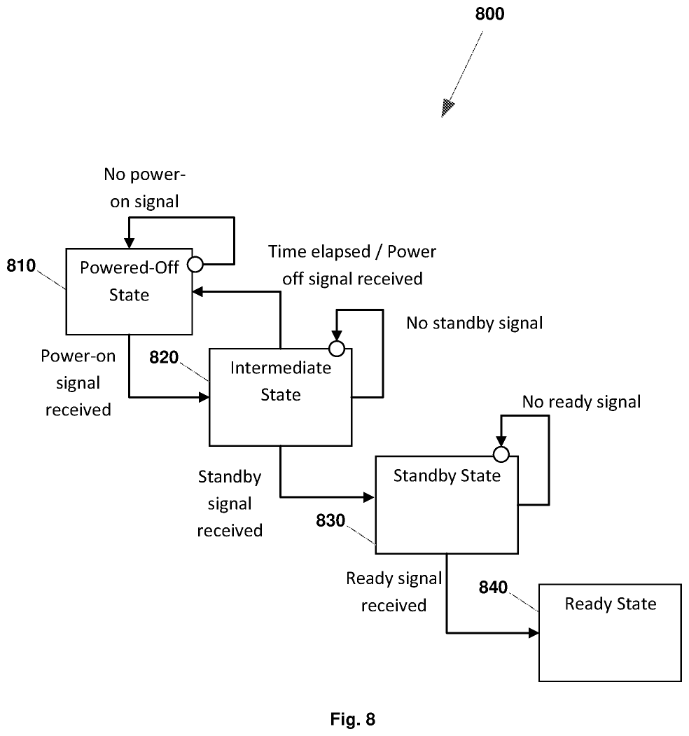

FIG. 8 shows an exemplary bootstrap process 800, according to embodiments of the present invention. The UAV capsule of the present invention may support four states, a powered-down state 810, where the capsule consumes essentially no internal or external power; an intermediate state 820 where the capsule consumes minimal power in order to enable functionality needed to receive further instructions; a standby state 830 where the capsule maintains readiness for launch on short notice but conserves power; and a ready state 840 where the capsule is ready to be launched with no prior notice. The UAV capsule receives signals, either from outside or generated by conditions inside the capsule, to advance in this process, continuing, optionally automatically, to the next state.

The intermediate state 820 is intended to facilitate UAV capsule use in launchers where it may be impossible to power-on the capsule on demand inside the launcher. The capsule may transition from the powered-off state 810 to the intermediate state 820 with a simple power-on signal, for example, a small voltage supplied externally to the capsule or a short-circuit directing a small current from a battery to a sensing circuit. In the intermediate state 820, the capsule and UAV are configured to activate the support controller (650 of FIG. 6) and (if necessary) an external communication means (e.g., a wireless datalink in the UAV) using the support battery's voltage. Moreover, the support controller is configured to “listen” for a further standby signal. The UAV may additionally be configured to return to a powered-off state 810 after a predefined time without receiving a standby signal, accommodating user error or allowing several capsules to share the same power-on signal.

The standby state 830 is intended to facilitate a quicker response time to launch, in designs when it is undesirable to simply bring the capsule to a state of readiness and keep it there until it is needed (for example, due to power consumption or safety concerns). Upon receiving a standby signal, the support controller (650 of FIG. 6) begins executing actions needed to ready the UAV for flight, such as, activating the flight controller and all other UAV components, conducting calibration and/or self-tests and loading mission information into the flight controller and payloads. The support controller may signal the power distribution controller (655 of FIG. 6), as necessary, to route power from the UAV and capsule's energy sources to relevant parts of the UAV. In this state, the support controller “listens” for a ready signal, necessary for transitioning to the ready state 840.

The ready state 840 is the ultimate result of the bootstrap process, and necessary for any successful launch. Upon receiving a ready signal, the support controller completes all operations necessary for immediate launch readiness and then enters a ready state 840. For example, it may activate all UAV's systems and configure them to be powered by the UAV's internal battery and may additionally command the UAV flight controller to arm its motors and enter a state where it can stabilize itself once it is launched. The ready state 840 may be excited by launching the capsule, by an external signal or a timer effecting a change to a different state absent a launch event, such as a power-off signal.

When the capsule is launched, the bootstrap process ends with the UAV transitioning to independent flight. The support controller, if implemented as a separate computer inside the capsule, is physically detached as a result of the launch process (due to remaining in the capsule as it separates from the UAV).

It will be noted that for some uses, stages or transitions of the exemplary process may be added, omitted or merged as necessary, while preserving the aspect of a bootstrap process, as the following examples show. In applications where capsules can be powered on individually on-demand, the intermediate state may be omitted, with a power-on signal commanding a transition directly to a standby state. In applications where long reaction times can be tolerated and a capsule can be powered-on an appropriate time before launch, the power-on signal may command an uninterrupted bootstrap process ending in the ready state. For applications where the capsule is intended to be tested while inside the launcher (e.g., the launcher embodies functions of a capsule tester), the bootstrap process may allow a transition from one or more stages of the bootstrap process to an additional state enabling the capsule to be tested.

It will be appreciated by persons skilled in the art that the present invention is not limited to what has been particularly shown and described hereinabove. Rather the scope of the present invention is defined by the appended claims and includes combinations and sub-combinations of the various features described hereinabove as well as variations and modifications thereof which would occur to persons skilled in the art upon reading the foregoing description.

1. A designated Unmanned Aerial Vehicle (UAV) capsule, comprising:
a capsule body, comprising:
a UAV; and
at least one maintenance connector; and
a support controller comprised in one of said capsule body and said UAV;
wherein said support controller is connected with said UAV and said at least one maintenance connector and configured to enable at least one of support actions and maintenance actions in said UAV while said UAV remains encapsulated in said capsule body.

2. The UAV capsule of claim 1, wherein said UAV is entirely encapsulated inside said capsule.

3. The UAV capsule of claim 1, wherein at least a part of said UAV forms at least a part of said capsule body.

4. The UAV capsule of claim 1, wherein said at least one of support actions and maintenance actions is selected from the group consisting of:
turning said UAV on;
carrying out at least one pre-flight test;
carrying out at least one pre-launch test;
loading data indicative of a mission to be performed; and
placing said UAV in a state of readiness for launch.

5. The UAV capsule of claim 1, wherein said at least one of support actions and maintenance actions is selected from the group consisting of:
updating software;
updating firmware;
charging batteries; and
discharging batteries.

6. The UAV capsule of claim 1, wherein said capsule is configured to perform a bootstrap process upon being activated, comprising:
transitioning between at least two states in a sequence comprising a low-power state suitable for long-term and a state of immediate readiness for launch; and
stopping at at least one state in said sequence, and continuing said sequence according to at least one of: awaiting at least one of a command or a signal to continue said sequence, completion of an internal process in said capsule and occurrence of a launch event.

7. The UAV capsule of claim 6, wherein said sequence comprises at least two of:
a powered-off state where said capsule is essentially powered-off and awaits a power-on signal;
an intermediate state where said capsule is minimally activated and awaits a standby command;
a standby state where said capsule is further activated and awaits a readiness for launch command; and
a ready state where said capsule awaits said capsule's launch.

8. A method of enabling at least one of support actions and maintenance actions in a UAV, comprising:
providing a capsule body, comprising
a UAV; and
at least one maintenance connector; and
a support controller comprised in one of said capsule body and said UAV;
enabling at least one of support actions and maintenance actions in said UAV while said UAV remains encapsulated in said capsule body.

9. The method of claim 8, wherein said UAV is entirely encapsulated inside said capsule.

10. The method of claim 8, wherein at least a part of said UAV forms at least a part of said capsule body.

11. The method of claim 8, wherein said at least one of support actions and maintenance actions is selected from the group consisting of:
turning said UAV on;
carrying out at least one pre-flight test;
carrying out at least one pre-launch test;
loading data indicative of a mission to be performed; and
placing said UAV in a state of readiness for launch.

12. The method of claim 8, wherein said at least one of support actions and maintenance actions is selected from the group consisting of:
updating software;
updating firmware;
charging batteries; and
discharging batteries.

13. The method of claim 8, further comprising performing a bootstrap process upon being activated, comprising:
transitioning between at least two states in a sequence comprising a low-power state suitable for long-term and a state of immediate readiness for launch; and
stopping at at least one state in said sequence, and continuing said sequence according to at least one of: awaiting at least one of a command or a signal to continue said sequence, completion of an internal process in said capsule and occurrence of a launch event.

14. The method of claim 13, wherein said sequence comprises at least two of:
a powered-off state where said capsule is essentially powered-off and awaits a power-on signal;
an intermediate state where said capsule is minimally activated and awaits a standby command;
a standby state where said capsule is further activated and awaits a readiness for launch command; and
a ready state where said capsule awaits the capsule's launch.

15.-20. (canceled)
